(19) United States
(12) Patent Application Publication
(10) Pub. No.: US 2016/0169404 A1
(43) Pub. Date: Jun. 16, 2016

(54) HIGH PRESSURE SOLENOID VALVE

(71) Applicant: Hyundai Motor Company, Seoul (KR)

(72) Inventors: Ki Ho Choi, Seoul (KR); Young-Min Choi, Yongin (KR); Chang-Ho Kim, Yongin (KR)

(21) Appl. No.: 14/923,606

(22) Filed: Oct. 27, 2015

(30) Foreign Application Priority Data
Dec. 11, 2014 (KR) 10-2014-0178105

(51) Int. Cl. F16K 31/06

(52) U.S. Cl. CPC F16K 31/0655

(57) ABSTRACT

A high pressure solenoid valve is provided and includes a valve housing connected to a body, having an entrance port and an outlet port to form a main flow path. The main flow path opens by engaging plungers A and B, disposed at a lower side of the valve housing, by magnetizing a fixed core disposed at one side of the valve housing by magnetic force of a solenoid coil wound around a circumference of the valve housing. The main flow path closes using a main spring elastically disposed between the fixed core and the plunger B. The fixed core is divided into a second fixed core positioned at one side of the valve housing by a disk cover coupled to the valve housing, and a first fixed core to reciprocate from the second fixed core toward the plunger B.

### CROSS-REFERENCE TO RELATED APPLICATION

This application claims under 35 U.S.C. §119(a) the benefit of Korean Patent Application No. 10-2014-0178105 filed on Dec. 11, 2014, the entire contents of which are incorporated herein by reference.

### BACKGROUND

(a) Technical Field

The present invention relates to a high pressure solenoid valve, and more particularly, to a charging path and a supply path of fuel unified by securing a maximum stroke of an operation of a plunger, thereby decreasing the valve size by reducing a flow path inside the valve, reducing the number of components, and decreasing the costs and weight of the valve.

(b) Background Art

Generally, a solenoid valve uses electromagnetic principles, and is an electronic valve, that switches an entrance between a cylinder and a plunger that transmits a physical force in a predetermined direction to open and close a flow path to adjust a flow of a fluid. The solenoid valve is commonly used in various industrial fields, including electric fields, electronic fields, and machine apparatus fields.

The solenoid valve opens and closes a flow path based on a movement of the plunger. In a high pressure gas system, in which high-pressure gas flows, the high-pressure gas disposed within the flow path flows into the solenoid valve and is applied to the plunger. In other words, the plunger cannot smoothly move due to resistance of the high-pressure gas, and the solenoid valve is unstably operated. Further, since a separate method for filtering foreign substances contained within gases is not provided at an entrance port of the high-pressure gas, the flow path of the solenoid valve is obstructed by the foreign substance mixed within the gas, thereby causing an erroneous operation of the solenoid valve.

Moreover, a vehicle using Compressed Natural Gas (CNG) or hydrogen as fuel stores fuel in a high-pressure container in a form of high-pressure gas. Generally, the vehicle adopts a solenoid-type electronic valve that is directly coupled to the high-pressure container. For example, the high-pressure solenoid valve typically has a closed structure. When a vehicle operation is engaged it becomes necessary to supply fuel, power is supplied to a solenoid coil and a plunger blocking a fuel supply path is opened. Additionally, to drive the valve, a pilot type including a plunger having dual structures is used to drive the valve with lower power in a high-pressure environment.

According to FIGS. 1A, 1B and 1C, when power is applied to a solenoid valve, plunger A overcomes power of a main spring and is displaced and gas within the interior of a tank flows to the exterior through an aperture disposed at a center of plunger B. When an external pressure increases to a level equal to that of an internal pressure of the tank, the plunger B is further displaced thereby opening a main flow path. In some examples fuel is charged through a separate flow path, including a check valve, when hydrogen is supplied, a lifted distance (e.g. stroke, A+B) of the plunger B is within about 0.3 mm, which is minimal A demanded supply flow rate may be satisfied even with the minimal lifted distance. However, when charging is performed, a flow rate of about 10 times or greater of the supply flow rate is required; however a flow area is minimal, thereby limiting the charging flow rate

To increase a stroke, the power lifting the plunger may increase a magnetic force by increasing the solenoid coil. Further, to satisfy the charging flow rate, a stroke must be increased by at least four times, which is incompatible with a current structure and size of the solenoid valve, thereby increasing the difficulty to apply the solenoid valve. Additionally, when fuel is charged, a mechanical check valve and the like are applied to a separate flow path. The check valve is opened when a charging pressure is greater than a pressure stored in the tank, and the check valve is obstructed or blocked when the charging pressure is less than or equal to the pressure stored in the tank. For example, when a fuel charging path and a fuel supply path are separated as described above, the valve has a complex internal structure and the number of components increases, thereby increasing costs of the valve and increasing internal leaking portions.

### SUMMARY

The present invention provides a high pressure solenoid valve, having a fixed core or plunger that may be divided and an auxiliary spring disposed between the divided fixed cores or plungers. A charging flow path and a supply flow path of fuel may be unified by securing a maximum stroke of an operation of the plunger. The valve size may be reduced by decreasing a flow path disposed within the valve, thereby decreasing the number of components, and reducing the costs and weight.

In one aspect of the present invention, a high pressure solenoid valve may include a valve housing connected to a body that may have an entrance port and an outlet port to create a main flow path. A main flow path of the body may be opened by engaging (e.g. sequentially) plunger A and plunger B, disposed at a lower side of the valve housing, by magnetizing a fixed core disposed at one side of the valve housing by magnetic force of a solenoid coil wound around a circumference of the valve housing. The main flow path may be closed by a main spring that may be elastically disposed between the fixed core and the plunger B. Further, the fixed core may be divided into a second fixed core that may be fixed at one side of the valve housing by a disk cover coupled to the valve housing, and a first fixed core to reciprocate from the second fixed core toward the plunger B.

Additionally, an auxiliary spring may apply a force to displace the first fixed core toward the plunger B elastically disposed between the first and second fixed cores. The plunger B may be divided into a first plunger and a second plunger, and the first plunger and the second plunger may be displaced in opposite directions by an auxiliary spring elastically disposed between the first plunger and the second plunger. For example, it may be possible to reduce the size of the solenoid valve by decreasing a flow path within the interior of the valve and decreasing the number of components, and it may be possible to reduce the costs and weight of the solenoid valve.

### BRIEF DESCRIPTION OF THE DRAWINGS

The above and other features of the present disclosure will be more apparent from the following detailed description taken in conjunction with the accompanying drawings.

FIG. 1A is an exemplary embodiment of a diagram of a cross-section and an operation state of a solenoid valve in the related art;

FIG. 1B is an exemplary embodiment of a diagram of a cross-section and an operation state of a solenoid valve in the related art; FIG. 1C is an exemplary embodiment of a diagram of a cross-section and an operation state of a solenoid valve in the related art;

FIG. 2. is an exemplary embodiment of a diagram of a cross-section and an operation state of a high-pressure solenoid valve according to an exemplary embodiment of the present invention;

FIG. 3. is an exemplary embodiment of a diagram of a cross-section and an operation state of a high-pressure solenoid valve according to an exemplary embodiment of the present invention;

FIG. 4 is an exemplary embodiment of a diagram of a cross-section and an operation state of a high-pressure solenoid valve according to an exemplary embodiment of the present invention; and

FIG. 5 is an exemplary embodiment of a diagram of a high-pressure solenoid valve according to another exemplary embodiment of the present invention.

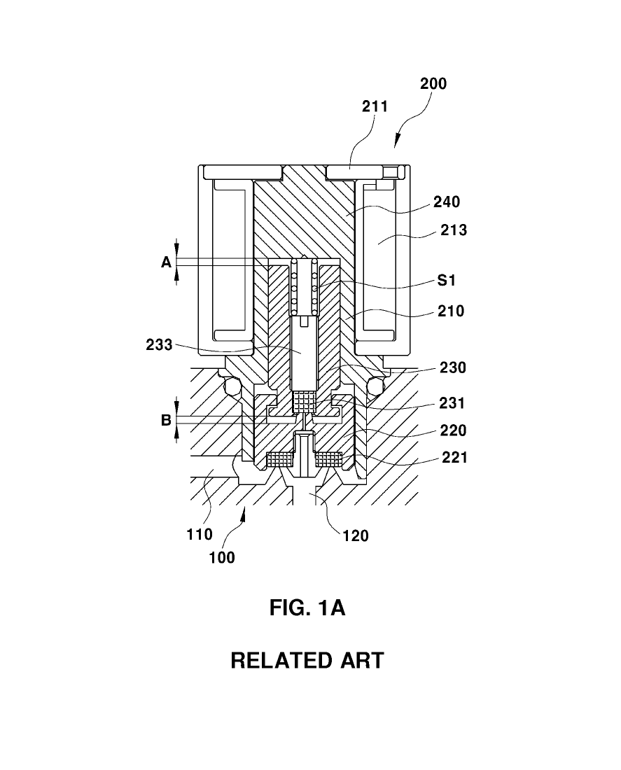

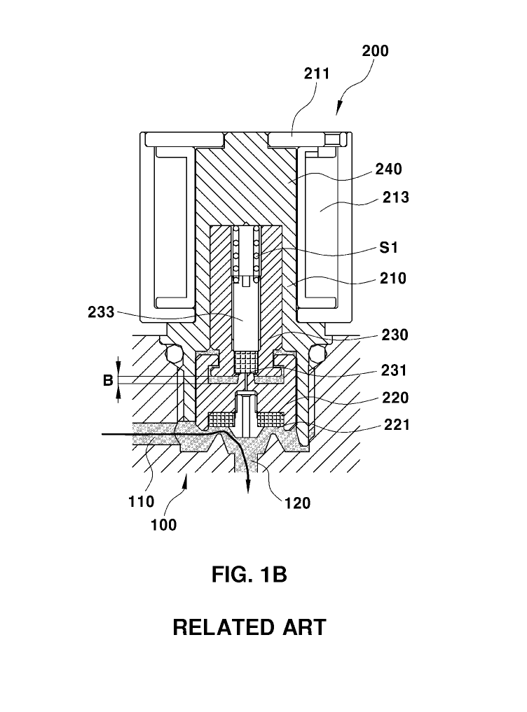

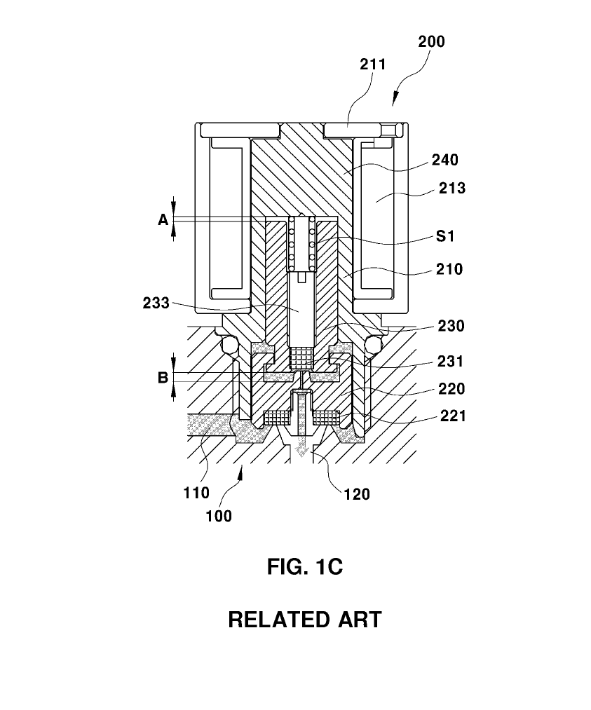

### DETAILED DESCRIPTION

Advantages and features of the invention and methods of accomplishing the same may be understood more readily by reference to the following detailed description of exemplary embodiments and the accompanying drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### First Exemplary Embodiment

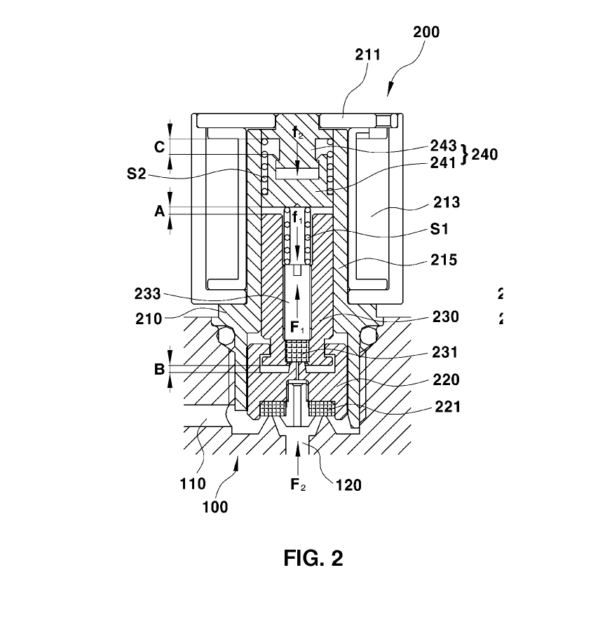

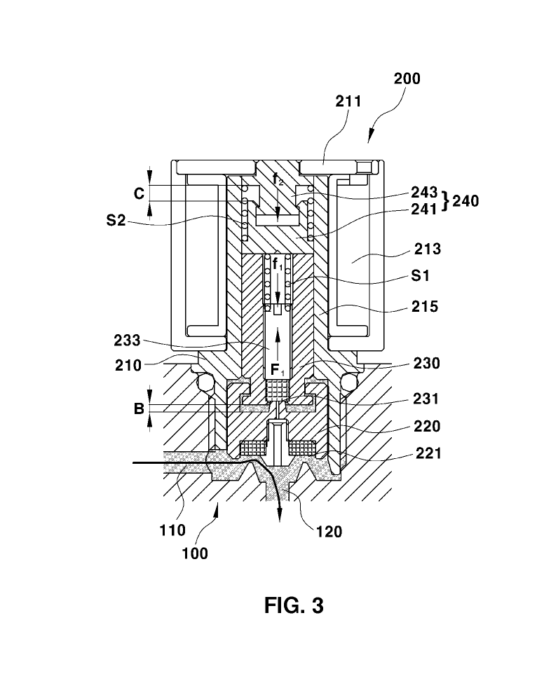

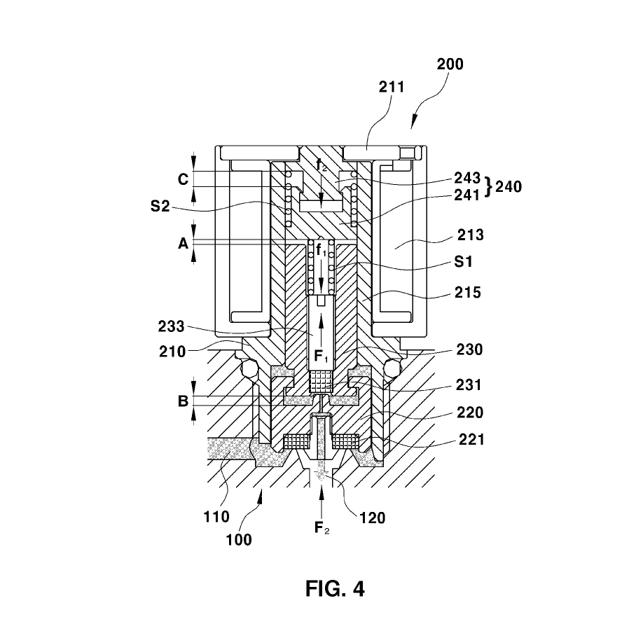

The present invention provides a high-pressure solenoid valve 200 that may include a valve housing 210 connected to a body 100 that may include an entrance port 110 and an outlet port 120 having a main flow path L1 as illustrated in FIGS. 2 to 4. The main flow path L1 of the body 100 may be opened by engaging (e.g. sequentially pulling) plunger A 220 and plunger B 230, which may be disposed at a lower side of the valve housing 200, by magnetizing a fixed core disposed at one side (e.g., a first side) of the valve housing 210 by magnetic force of a solenoid coil 213 wound around a circumference of the valve housing 210.

The high-pressure solenoid valve 200 may be configured to close the main flow path L1 using a main spring S1 that may be elastically disposed between the fixed core 240 and the plunger B 230. For example, the fixed core 240 may be divided into a second fixed core 243 positioned at one side of the valve housing 210 by a disk cover 211 coupled to the valve housing 210, and a first fixed core 241 to return from the second fixed core 243 toward the plunger B 230. An auxiliary spring S2 may engage the first fixed core 241 and displace the first fixed core toward the plunger B 230 that may be elastically disposed between the first and second fixed cores 241 and 243.

### Second Exemplary Embodiment

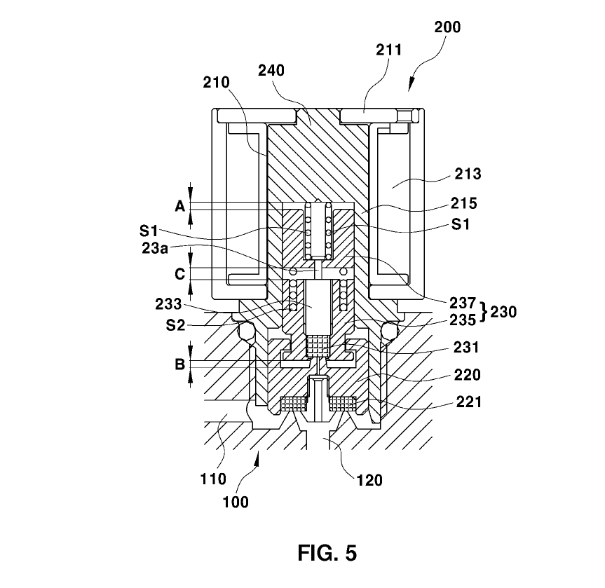

In another exemplary embodiment a high-pressure solenoid valve 200 may include a valve housing 210 connected to a body 100 that may include an entrance port 110 and an outlet port 120 having a main flow path L1 as illustrated in FIG. 5. The main flow path L1 of the body 100 may be opened by engaging (e.g. sequentially pulling) plunger A 220 and plunger B 230, that may be disposed at a lower side of the valve housing 200, by magnetizing a fixed core disposed at one side of the valve housing 210 by magnetic force of a solenoid coil 213 that may be wound around a circumference of the valve housing 210.

The high-pressure solenoid valve 200 may be configured to close the main flow path L1 using a main spring S1 elastically disposed between the fixed core 240 and the plunger B 230. For example, the plunger B 230 may be divided into a first plunger 235 and a second plunger 237. The first plunger 235 and the second plunger 237 may be displaced in opposite directions by an auxiliary spring S2 elastically disposed between the first plunger 235 and the second plunger 237. In particular, a coupling pin 239 may be disposed within the first plunger 235 and may prevent the second plunger 237 from being separated from the first plunger 235.

Further, the first and second exemplary embodiments may include a plunger B sheet fixer 233 that may pass through a center of the plunger B 230 by screw-engagement, but is not limited thereto. Additionally, a plunger B sheet 231 may open or close a charging path L2 formed within the plunger A 220 and may be formed at one side of the plunger B 230. Further, the charging path L2 may pass through a center of the plunger A 220, and a plunger A sheet 221 that may open and close the main flow path L1 that may be formed at a circumference of the plunger A 220. In other words, the valve housing 210 may be a non-magnetic substance, and power may be applied to the solenoid coil 213, electromagnetism may be induced around the solenoid coil 213. The plunger B (e.g. magnetic substance), the first fixed core, and the second fixed core 243 may be magnetized, gravitation (e.g. pulling force) may be applied, and the plunger B 230 may be displaced (e.g. lifted) to open the valve, and the second fixed valve 243 may be fixed by the disk cover 211 coupled with the valve housing 210 by screw-engagement or welding.

Furthermore, to open the valve by lifting the plunger B 230 with the magnetic force of the solenoid coil, the second fixed core 243 and the first fixed core 241 may be magnetized and gravitation for engaging (e.g. pulling) the plunger B 230 may to be generated. In particular, to magnetize the first and second fixed cores 241 and 243, the auxiliary spring S2 may not be operated, but may support the fixed core 240 when the valve is disposed in the open position with power applied by the wound solenoid coil 213. The second fixed core 243 may have a force applied (e.g. pushed by pressure), at which hydrogen may be charged, regardless of the magnetizing force necessary to dispose the valve in an open. An effect and operation of the present invention may include the aforementioned configuration will be described in detail with reference to the accompanying drawings.

According to the operation state illustrated in FIGS. 2 to 4, the pressure of the gas may be charged by dividing the fixed core 240 into two parts and the fixed core 240 may be formed in a mutual latching structure. The auxiliary spring S2 may apply a force into the solenoid valve, and the force may be transmitted from the plunger A 220 to the plunger B 230. Additionally, the force may be transmitted to the first fixed core 241, to fully compress the main spring S1 and the auxiliary spring S2, and thus the force (e.g. a pushing quantity) applied to the entire plunger B 230 may be increased. Accordingly, the main flow path 11 may be formed, and may thereby the sufficient amount of fuel may be supplied.

Additionally, the plunger A 220 and the plunger B 230 may be engaged (e.g. sequentially lifted) by magnetic force of the solenoid coil 213 by a stroke A while hydrogen is supplied to open the valve. In particular, power of the auxiliary spring S2 and the main spring S1 may be greater than the magnetizing force of the first and second fixed cores 241 and 243 by the solenoid coil 213 to maintain the stroke A, to improve valve operating performance. When the solenoid operating force is F1, and the force by charging pressure is F2, power of the main spring 1 may be f1, and power of the main spring 2 may be f2. For example f1<F1<f2<F2 are acceptable (e.g. appropriate). Additionally, compared to the total stroke in the related art including stroke A+stroke B, the present exemplary embodiment may include a stroke C in addition to the total stroke, which may enable a longer stroke and may secure the charging path L2 for charging hydrogen.

Further, a valve guide 215 configured to guide the plunger B 230 may be formed within the valve housing 210 in a longitudinal direction of the valve housing 210. The valve guide 215 may be a non-magnetic substance. For example, when power is applied to the solenoid coil 213, the plunger B that is a magnetic substance may be magnetically induced by electromagnetism around the solenoid coil 213. The first fixed core 241 and the second fixed core 243 may be magnetized and gravitation may be applied, so that the plunger B 230 may be engaged (e.g. lifted) to open the valve. In other words, the second fixed valve 243 may be coupled with the valve guide 215 by screw-engagement or welding.

For example, to displace (e.g. lift) the plunger B 230 with minimal magnetic force of the solenoid coil 213 and open the valve, the second fixed core 243 and the first fixed core 241 may be magnetized to generate gravitation of pulling the plunger B, and the second fixed core 243 and the first fixed core 241 may be positioned at an inner side of the solenoid coil 213 to be magnetized, so that the valve guide 215 that is a non-magnetic substance may be required. Further, when power is applied to the solenoid coil 213 to open the valve, the auxiliary spring S2 may not be operated, and may support the first fixed core 241. For example, when hydrogen is charged, the auxiliary spring S2 may be compressed by the pushed first fixed core 241 regardless of application of power. According to the exemplary embodiments of the invention, it may be possible to reduce the size of the solenoid valve by decreasing a flow path within the valve and decreasing the number of components, and it is possible to reduce costs and weight of the solenoid valve.

The invention has been described in connection with what is presently considered to be exemplary embodiments, but on the contrary, is intended to cover various modifications and equivalent arrangements included within the sprit and scope of the appended claims. In addition, it is to be considered that all of these modifications and alterations fall within the scope of the present invention.

What is claimed is:

1. A high-pressure solenoid valve, comprising:
a main flow path of a valve housing open and closed to supply and charge gas by engaging plunger A and plunger B by magnetic force of a fixed core magnetized by magnetic force of a solenoid coil,
wherein the fixed core is divided into a second fixed core, which is fixed at one side of the valve housing by a disk cover coupled to the valve housing, and a first fixed core reciprocating from the second fixed core toward the plunger B.

2. The high-pressure solenoid valve of claim 1, further comprising:
an auxiliary spring configured to elastically displace the first fixed core toward the plunger B between the first fixed core and the second fixed core.

3. A high-pressure solenoid valve, comprising:
a main flow path of a valve housing open and closed to supply and charge gas by engaging plunger A and plunger B by magnetic force of a fixed core magnetized by magnetic force of a solenoid coil,
wherein the plunger B is divided into a first plunger and a second plunger, and
wherein the first plunger and the second plunger are displaced in opposite directions by an auxiliary spring elastically disposed between the first plunger and the second plunger.

4. The high-pressure solenoid valve of claim 3, further comprising:
a coupling pin disposed at the first plunger to prevent the second plunger from being separated from the first plunger.

5. The high-pressure solenoid valve of claim 1, wherein a plunger B sheet fixer passes through a center of the plunger B by screw-engagement, and a plunger B sheet, opens and closes a charging flow path formed in the plunger A, is formed at one side of the plunger B.

6. The high-pressure solenoid valve of claim 1, wherein a charging flow path passes through a center of the plunger A, and a plunger A sheet, which opens and closes the main flow path, is formed at a circumference of the plunger A.

7. The high-pressure solenoid valve of claim 1, wherein the valve housing further includes:
a valve guide configured to guide the plunger B in a longitudinal direction of the valve housing, to induce the plunger B that is a non-magnetic substance by electromagnetism of a solenoid coil according to application of power,
wherein the plunger B is engaged via gravitation force applied to the first fixed core and the second fixed core from each other according to magnetization of the first fixed core and the second fixed core to open the valve.

8. The high-pressure solenoid valve of claim 1, wherein the first fixed core and the second fixed core include latching structures to prevent the first fixed core from being separated from the second fixed core.

9. The high-pressure solenoid valve of claim 3, wherein a plunger B sheet fixer passes through a center of the plunger B by screw-engagement, and a plunger B sheet, opens and closes a charging flow path formed in the plunger A, is formed at one side of the plunger B.

10. The high-pressure solenoid valve of claim 3, wherein a charging flow path passes through a center of the plunger A, and a plunger A sheet, which opens and closes the main flow path, is formed at a circumference of the plunger A.
